(19) United States
(12) Patent Application Publication
(10) Pub. No.: US 2007/0195260 A1
(43) Pub. Date: Aug. 23, 2007

(54) ANTIMICROBIAL SPECTACLE

(75) Inventors: Anders Olsson, Satofta (SE); Huan Kiak Toh, Fullarton (AU); Fang Chen, Hallett Cove (AU)

Correspondence Address: CLIFF D. WESTON;MICROBAN PRODUCTS COMPANY, 1115 VANSTORY DRIVE, SUITE 125, HUNTERSVILLE, NC, 28078, US

(73) Assignee: Microban Products Company, Huntersville, NC (US)

(21) Appl. No.: 11/558,491

(22) Filed: Nov. 10, 2006

Related U.S. Application Data
(63) Continuation-in-part of application No. 11/359,007, filed on Feb. 22, 2006.

(51) Int. Cl. G02C 1/00

(52) U.S. Cl. 351/43

(57) ABSTRACT

Antimicrobial eyeglasses have an antimicrobial lens, wherein an antimicrobial agent can be incorporated into the lens material or into a coating material of a coating layer affixed to the lens. The antimicrobial agent is essentially non-releasably incorporated or affixed, such that the lens exhibits a persistent antimicrobial property.

### RELATED APPLICATION DATA

This application is a continuation-in-part of and claims priority to U.S. Ser. No. 11/359,007, filed on Feb. 22, 2006.

### FIELD OF THE INVENTION

The invention relates generally to a spectacle or eyeglass frame, and more particularly to a spectacle or an eyeglass frame, or part thereof, having an antimicrobial property.

### BACKGROUND OF THE INVENTION

Glasses, spectacles, or eyeglasses are frames bearing lenses worn in front of the human eyes. Generally the lenses provide corrective light refraction, although “costume” eyeglasses are known to be worn for purely aesthetic reasons. Costume glasses can include both untinted lenses and sunglasses. Additionally, eyewear can be donned for protective purposes, such as safety glasses worn by persons near machinery, chemicals, and the like.

Eyeglass lenses originally were made from glass, but many are now made from plastic. Conventionally preferred lens materials include polycarbonate, CR-39® (poly diallyl glycol carbonate), and Trivex® (a polyurethane or polyurethane-polyurea based material). Safety glasses are usually made with shatter-resistant plastic lenses to protect the eye from flying debris as well as from the lenses of the safety glasses themselves.

Coatings can be applied to most plastic lenses. Scratch-resistant coatings give treated lenses scratch resistance similar to that of glass. Non-reflective coatings also can be applied to lenses. The coating material can be an acrylic film layer applied to the lens.

Sunglasses and/or eyeglasses fitted with corrective lenses typically are worn by only one user, as the type and degree of correction will be specific to that user. Conversely, safety glasses (usually having clear, non-corrective lenses) may be worn by many different users in a laboratory or industrial setting.

In either instance, the eyeglasses are handled by the user in the course of putting on and removing the glasses. Contact with the wearer's hands facilitates the deposit of microbes onto the eyeglasses, permitting the latter to act as a vector to deliver deposited microbes to a second wearer or to a susceptible part of the first wearer's person. Microbial communication can be especially prevalent in health care and laboratory settings.

### DETAILED DESCRIPTION OF THE PREFERRED EMBODIMENT(S)

As used herein the term “antimicrobial agent” is used to encompass materials, typically chemicals, that kill microbes or retard the growth of microbes to a statistically significant degree. The term “antimicrobial agent” should be understood to include bactericides, fungicides, and other such agents. The terms “antimicrobial”, “bactericide” and “fungicide” are well-known to those skilled in the art and their meanings will be readily discerned by the context in which each term is used.

The elements of a spectacle frame (e.g., front member, side or temple member, nose bridge) are very well known in the art and need not be shown by illustration here.

In a first lens embodiment, a polycarbonate lens has applied thereon an acrylic coating layer, the acrylic layer having disposed therein a first antimicrobial agent. The antimicrobial acrylic coating does not perturb the optical properties of the lens, but imparts an antimicrobial character to the finished lens.

Prototype polycarbonate lenses were made having an acrylic coating layer thereon with 2,4,4′-trichloro-2′-hydroxydiphenyl ether incorporated therein at concentrations of 0.05%, 0.2%, 0.3%, 0.5% and 1.0% by weight of the finished lens plastic. The resultant lenses demonstrate an antimicrobial property in laboratory tests against Staphylococcus aureus and Escherichia coli 0157. Lenses at all sampled concentrations showed a reduction in microbe levels in the range of about 90% to about 99% after 24 hours in both S. aureus and E. coli 0157 cultures.

A lens can be coated with more than one coating layer. In such cases, the antimicrobial agent preferably is present at least in the outermost coating layer—that is, the most superficial coating layer. Such placement maximizes the probability that microbes contacting the lenses will contact the antimicrobial coating layer.

Some migration of the antimicrobial agent within the coating layer or adjacent structures can be expected. The degree of migration is dependent on the particular materials as well as the identity of the incorporated antimicrobial agent(s). In the above example, 2,4,4′-trichloro-2′-hydroxydiphenyl ether migrates slowly in acrylic materials. For this example, therefore, it is preferred that the antimicrobial agent be disposed in the topmost coating layer where multiple coatings are applied to the lens.

Alternative antimicrobial agents include triclosan (2,4,4′-trichloro-2′-hydroxydiphenyl ether); ortho phenyl phenol (OPP; CAS No. 90-43-7); isothiazolone-based compounds such as 1,2-benzisothiazolin-3-one (CAS No. 2634-33-5), N-butyl-1,2-benzisothiazolin-3-one (CAS No. 4299-07-4), 2-octyl-isothiazolone (CAS No. 26530-20-1), 4,5-dichloro-2-N-octyl-3(2H)isothiazolone (CAS No. 64359-81-5), methyl-3(2H)-isothiazolone (CAS No. 2682-20-4), and chloro-2-methyl-3(2H)-isothiazolone (CAS No. 26172-55-4); diiodomethyl p-tolylsulfone; zinc and sodium pyrithiones; azoles (such as propiconazoles), polyhexamethylene biguanide hydrochloride (PMBH); 3,4,4′-trichlorocarbanilide; and barium metaborate.

It will therefore be readily understood by those persons skilled in the art that the present composition and methods are susceptible of broad utility and application. Many embodiments and adaptations other than those herein described, as well as many variations, modifications and equivalent arrangements, will be apparent from or reasonably suggested to one of ordinary skill by the present disclosure and the foregoing description thereof, without departing from the substance or scope thereof. Accordingly, while the present composition and methods have been described herein in detail in relation to its preferred embodiment, it is to be understood that this disclosure is only illustrative and exemplary and is made merely for purposes of providing a full and enabling disclosure. The foregoing disclosure is not intended or to be construed to limit or otherwise to exclude any such other embodiments, adaptations, variations, modifications and equivalent arrangements.

What is claimed is:

1. Antimicrobial eyeglasses, comprising:
an eyeglass lens member constructed of a lens material;
a first coating layer associated with the lens; and
a first antimicrobial agent essentially non-releasably disposed within one of the lens material or the first coating layer.

2. The antimicrobial eyeglasses of claim 1 wherein the first antimicrobial agent is disposed within the lens material.

3. The antimicrobial eyeglasses of claim 1 wherein the first antimicrobial agent is disposed within the first coating layer.

4. The antimicrobial eyeglasses of claim 3 wherein the first coating layer is an acrylic material.

5. The antimicrobial eyeglasses of claim 1 wherein the antimicrobial agent is selected from the group consisting of 2,4,4′-trichloro-2′-hydroxydiphenyl ether; o-phenyl phenol; an isothiazolone-based compound; diiodomethyl p-tolylsulfone; a zinc pyrithione, a sodium pyrithione; an azole; polyhexamethylene biguanide hydrochloride; and 3,4,4′-trichlorocarbanilide.
